(19) United States
(12) Patent Application Publication
(10) Pub. No.: US 2025/0128284 A1
(43) Pub. Date: Apr. 24, 2025

(54) FLUID APPLICATOR WITH PROPORTIONAL VALVE

(71) Applicant: GM Global Technology Operations LLC, Detroit, MI (US)

(72) Inventor: Rushabh Patel, Troy, MI (US)

(73) Assignee: GM Global Technology Operations LLC, Detroit, MI (US)

(21) Appl. No.: 18/493,316

(22) Filed: Oct. 24, 2023

(51) Int. Cl. B05C 5/02; F15B 13/044

(52) U.S. Cl. CPC B05C 5/0216; B05C 5/0225; F15B 13/0442

(57) ABSTRACT

A fluid applicator system for applying fluid to a workpiece includes an arm movable relative to the workpiece and a proportional valve attached to the arm and movable with the arm relative to the workpiece, the proportional valve configured to dispense fluid onto the workpiece at predetermined locations when the arm is moved relative to the workpiece.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to fluid applicators and, more particularly, to a fluid applicator incorporating a proportional valve.

Sealants and adhesives are widely used in automotive manufacturing. For example, sealants may be used to seal joints between body panels and between a body panel and a pane of glass. Adhesives may be used to join components together and, as such, are referred to as structural adhesives. Finally, sealants and/or adhesives may be used to adhere a component to a vehicle while simultaneously sealing a joint between the component and adjoining structure. For example, a sealant/adhesive may be applied at a junction of a windshield or windscreen and an opening of a vehicle body to both attach the windshield or windscreen to the vehicle body and to seal a joint between the windshield or windscreen and the vehicle body to prevent water and other debris from entering a vehicle cabin during use of the vehicle.

During vehicle manufacturing, application of an adhesive or sealant is typically performed with the adhesive or sealant in a uncured, fluid form. The fluid is applied to an area to join and/or seal two components together. Once the adhesive or sealant is applied, the adhesive or sealant is allowed to cure, thereby allowing the material of the adhesive or sealant to join and/or seal a junction between two or more components.

Adhesives or sealants can be manually applied to one or more components to be joined and/or sealed or can be applied by an automated system. In the case of a manual operation, an operator utilizes a wand that is fluidly coupled to a source of adhesive or sealant and applies the adhesive or sealant to one or more components to be joined and/or sealed by depressing an actuator associated with the wand to dispense a desired amount of adhesive or sealant. In the case of an automated system, a series of components are utilized to dispense the adhesive or sealant including a pump, a servo motor, a gear box, one or more meters, a solenoid valve, and one or more applicators.

While the foregoing methods adequately apply adhesives and sealants to automotive components during manufacturing, the foregoing methods are either imprecise and/or are complex and costly. In the case of a manual system, successful application of the adhesive or sealant is based on where a human operator places a wand, the degree to which an applicator is depressed, and the speed with which the wand is moved relative to a workpiece. With respect to conventional automated systems, reliability of adhesive/sealant application is improved with respect to a manual system but the resulting system is complex and, as a result, costly both in terms of installation and maintenance. Accordingly, a straightforward automated system for applying an adhesive and/or sealant in an auto manufacturing environment is needed.

### SUMMARY

In one configuration, a fluid applicator system for applying fluid to a workpiece is provided and includes an arm movable relative to the workpiece and a proportional valve attached to the arm and movable with the arm relative to the workpiece, the proportional valve configured to dispense fluid onto the workpiece at predetermined locations when the arm is moved relative to the workpiece.

The fluid applicator system may include one or more of the following optional features. For example, the proportional valve may be in fluid communication with a reservoir containing the fluid. A pump may be in fluid communication with the fluid disposed in the reservoir, the pump configured to direct fluid from the reservoir into the proportional valve. Additionally or alternatively, the proportional valve may include a housing and a valve body slidably disposed within the housing and movable into a plurality of open positions between a fully closed position preventing flow of the fluid from the reservoir to the workpiece and a fully open position permitting flow of the fluid from the reservoir to the workpiece, the plurality of open positions providing different flow volumes of the fluid through the proportional valve to the workpiece.

In one configuration, the fluid may be an adhesive. In another configuration, the fluid may be a sealant. In yet another configuration, the fluid may be a combination adhesive/sealant.

A volume of fluid dispensed by the proportional valve may be synchronized with movement of the arm to dispense fluid onto the workpiece at a predetermined bead size. Additionally or alternatively, the proportional valve may include a solenoid configured to move a valve body relative to and within a housing of the proportional valve to control the volume of fluid dispensed from the proportional valve onto the workpiece. The valve body may be configured to be moved into a plurality of open positions to control a volume of fluid dispensed from the housing based on an analog signal applied to the solenoid.

In another configuration, a system is provided and includes data processing hardware and memory hardware in communication with the data processing hardware, the memory hardware storing instructions that when executed on the data processing hardware cause the data processing hardware to perform operations. The operations include (i) programming a path-of-movement of an arm relative to a workpiece, the path-of-movement defining a bead location of at least one of an adhesive and a sealant, (ii) moving a proportional valve with the arm relative to the workpiece, the proportional valve moving with the arm along the path-of-movement, and (iii) moving a valve body of the proportional valve from a closed position to one of a plurality of open positions to dispense a fluid from the proportional valve onto the workpiece as the arm and the proportional valve are moved along the path-of-movement.

The system may include one or more of the following optional features. For example, the proportional valve may be in fluid communication with a reservoir containing the at least one of the adhesive and the sealant. The at least one of the adhesive and the sealant may be directed to the proportional valve by a pump in fluid communication with the at least one of the adhesive and the sealant disposed within the reservoir.

In one configuration, a speed of the arm may be synchronized with a position of the valve body to dispense the fluid onto the workpiece at a desired bead size. Additionally or alternatively, moving the valve body from a closed position to one of a plurality of open positions may include supplying the proportional valve with an analog signal. Supplying the proportional valve with an analog signal may include supplying the analog signal to a solenoid associated with the proportional valve.

The proportional valve may include a piston and a connecting rod, the connecting rod extending between and connecting the piston and the valve body. Further, the proportional valve may include a solenoid disposed proximate to the piston, the solenoid configured to move the piston relative to a housing of the proportional valve in response to a signal received by the solenoid. The signal may be an analog signal. Additionally or alternatively, movement of the piston relative to the housing may cause simultaneous movement of the valve body into the closed position or one of the plurality of open positions.

### BRIEF DESCRIPTION OF THE DRAWINGS

The drawings described herein are for illustrative purposes only of selected configurations and are not intended to limit the scope of the present disclosure.

FIG. 1 is a perspective view of a fluid applicator system in accordance with the principles of the present disclosure used in conjunction with a fixture and a workpiece;

FIG. 2 is a cross-sectional view of a proportional valve for use with the fluid applicator system of FIG. 1;

FIG. 3 is a schematic representation of a dispensing module for controlling the fluid applicator system of FIG. 1; and

FIG. 4 is a flowchart detaining operation of the dispensing module of FIG. 3.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to.” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

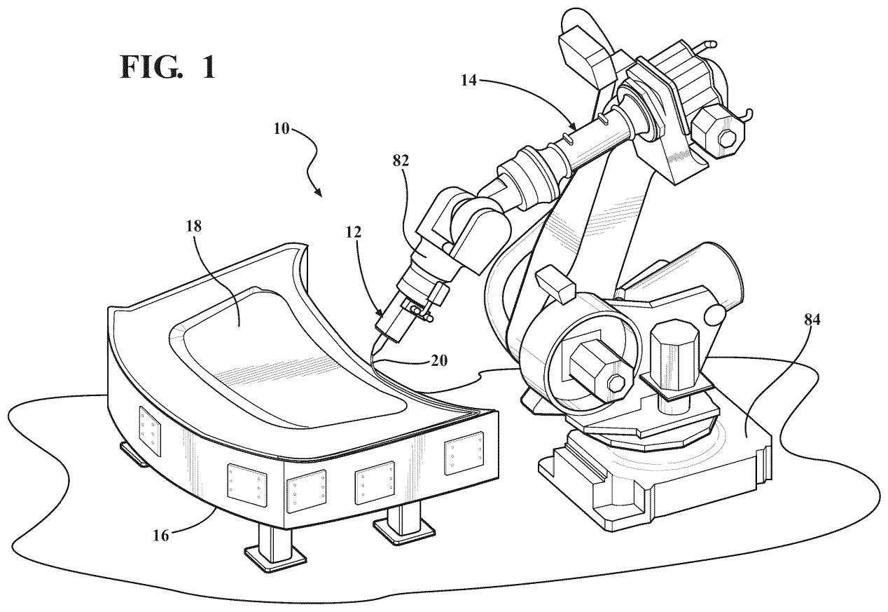

With reference to FIG. 1, a fluid applicator system (FAS) 10 is provided and includes an applicator 12 and a robot 14 configured to support and move the applicator 12 relative to a fixture 16 and a workpiece 18. While the FAS 10 will be described and shown hereinafter and in the drawings as including a robot 14, the FAS 10 could include an applicator 12 that is fixed relative to the fixture 16 such that the applicator 12 does not move relative to the workpiece 18 secured to the fixture 16 when the applicator 12 dispenses an adhesive or a sealant on the workpiece 18. Further, while the FAS 10 could dispense a fluid that is an adhesive, a sealant, or a combination adhesive/sealant, the FAS 10 will be described hereinafter as dispensing an adhesive in liquid form that is subsequently cured and joins a workpiece 18 to an external structure (not shown). For example, as shown in FIG. 1, the applicator 12 is shown as dispensing an adhesive 20 onto a workpiece 18 such as a vehicle window for use in securing and sealing the window to a vehicle body (not shown).

The applicator 12 is a proportional valve and includes a housing 22, a solenoid 24, a plunger 26, and an applicator tip 28. The housing 22 supports the solenoid 24, the plunger 26, and the applicator tip 28 and includes a first portion 30 assembled to a second portion 32. The first portion 30 includes a bore 34 and a recess 36 formed into the bore 34. A sleeve 38 is fitted to the bore 34 and slidably receives the plunger 26 therein. The second portion 32 of the housing 22 is attached to the first portion 30 of the housing 22 and includes a bore 40 in fluid communication with the bore 34 of the first portion 30. As with the bore 34 of the first portion 30, the bore 40 of the second portion 32 of the housing 22 slidably receives the plunger 26 therein.

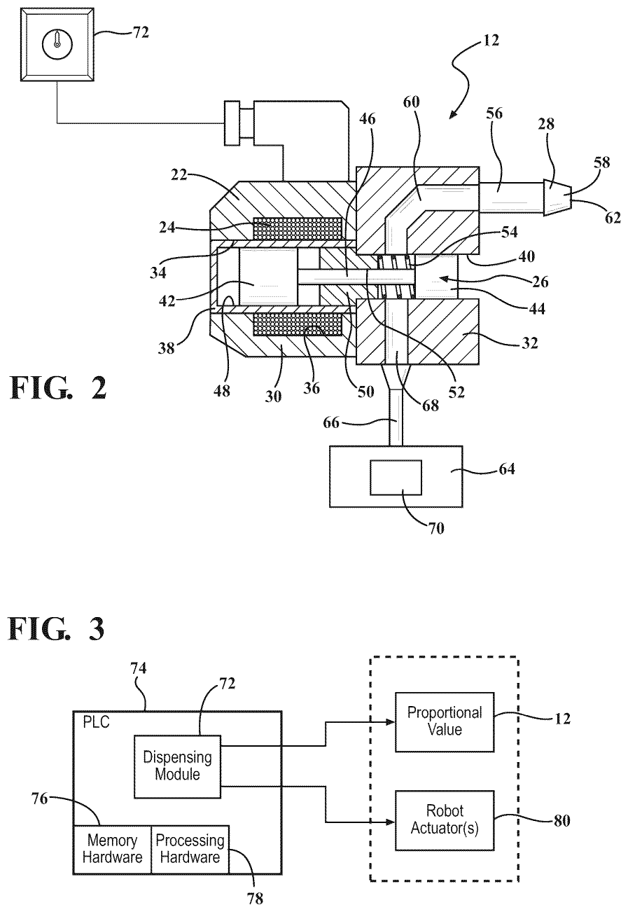

The solenoid 24 is received within the recess 36 with a portion of the sleeve 38 disposed between the bore 34 and the plunger 26, as shown in FIG. 2. As will be described in greater detail below; the solenoid 24 is selectively energized to control a position of the plunger 26 relative to the housing 22.

The plunger 26 includes a piston 42, a valve body 44, and a connecting rod 46 extending between and connecting the piston 42 and the valve body 44. The piston 42 is slidably received within a bore 48 of the sleeve 38 while the valve body 44 is slidably received within the bore 40 of the second portion 32 of the housing 22. As shown in FIG. 2, the connecting rod 46 extends between and joins the piston 42 and the valve body 44 such that the connecting rod 46 spans a junction of the first portion 30 of the housing 22 and the second portion 32 of the housing 22.

A fitting 50 is disposed within the bore 48 of the sleeve 38 and within the bore 40 of the second portion 32 of the housing 22 at a junction of the first portion 30 of the housing 22 and the second portion 32 of the housing 22 and includes a bore 52 formed therethrough. The bore 52 of the fitting 48 is in fluid communication with the bore 48 of the sleeve 38 and with the bore 40 of the second portion 32 of the housing 22. As shown in FIG. 2, the bore 52 of the fitting 50 slidably receives the connecting rod 46 of the plunger 26 and serves to support and position the plunger 26 relative to and within the first portion 30 of the housing 22 and the second portion 32 of the housing 22.

A biasing element 54 is disposed within the bore 40 of the second portion 32 of the housing 22 and is disposed between the fitting 50 and the valve body 44. In the configuration illustrated, the biasing element 54 is a coil spring having a first end abutting an end of the fitting 50 and a second end abutting an end of the valve body 44 and serves to bias the plunger 26 in an open direction. With reference to FIG. 2, the biasing element 54 biases the plunger 26 to the right (i.e., in a direction away from the first portion 30 of the housing 22).

The applicator tip 28 is attached to the second portion 32 of the housing 22 and includes a conduit 56 and a tip 58. The conduit 56 is fixedly attached to the second portion 32 of the housing 22 and is in fluid communication with a first passage 60 formed into the second portion 32. As shown in FIG. 2, the first passage 60 extends from the conduit 56 to the bore 40 of the second portion 32 of the housing 22 to place the conduit 56 in fluid communication with the bore 40 of the second portion 32. The tip 58 extends from a distal end of the conduit 56 and is in fluid communication with the conduit 56. Accordingly, the tip 58 is in fluid communication with the bore 40 of the second portion 32 of the housing 22 via the conduit 56. As shown in FIG. 2, the tip 58 includes a tapered, outer profile to provide an outlet port 62 with a smaller diameter than an inner diameter of the conduit 56.

The applicator 12 is in fluid communication with a reservoir 64 via a conduit 66. Specifically, the second portion 32 of the housing 22 includes a second passage 68 in fluid communication with the bore 40 at a first end and with the reservoir 64 at a second end. In one configuration, the second passage 68 is aligned with the first passage 60 across the bore 40. Accordingly, the first passage 60 and the second passage 68 are in fluid communication with one another via the bore 40).

The reservoir 64 contains liquid adhesive that may be directed toward the applicator 12 during use. Specifically, a pump 70 disposed within or proximate to the reservoir 64 may exert fluid pressure on the liquid adhesive disposed within the reservoir 64 to direct the liquid adhesive into the second passage 68 of the second portion 32 of the housing 22 during operation of the FAS 10. The pump 70 is schematically shown in FIG. 2 as being disposed within the reservoir 64.

Finally, the applicator 12 is in communication with a dispensing module 72 (FIGS. 2 and 3). The dispensing module 72 may supply the applicator 12 with an analog signal to control movement of the plunger 26 within and relative to the housing 22 to control the amount of adhesive 20 dispensed from the housing at the tip 58. The dispensing module 72 may supply the analog signal to the applicator 12 by supplying the applicator 12 with a pulse-width modulated (PWM) signal to control a position of the plunger 26 relative to and within the housing 22. As will be described in greater detail below; the position of the plunger 26 within the housing 22 dictates the amount of adhesive 20 dispensed from the housing 22 at the tip 58.

With particular reference to FIGS. 2 and 3, operation of the applicator 12 will be described in detail. As shown in FIG. 3, the dispensing module 72 may be implemented in a programmable logic controller (PLC) 74, which includes memory hardware 76 and processing hardware 78. The memory hardware 76 may store programming instructions that when executed by the processing hardware 78 cause the applicator 12 to dispense a desired amount of adhesive 20 from the tip 58. As shown in FIG. 3, the dispensing module 72 is in communication with the applicator 12 and with one or more actuators 80 associated with the robot 14 to allow the PLC 74 to control movement of the robot 14 during application of the adhesive. Specifically, placing the PLC 74 in communication with both the actuator 12 and the robot 14 allows the PLC 74 to synchronize a rate and/or an amount of adhesive dispensed from the tip 58 with a speed of movement of the robot 14 to ensure a resulting bead of adhesive 20 disposed on the workpiece 18 has a desired size (i.e., width and/or depth).

When a workpiece 18 is inserted into the fixture 16, a position of the workpiece 18 relative to the robot 14 is known, as the fixture 16 is in a fixed position relative to the robot 14. At this point, the actuator 12 is in a fully closed state such that the valve body 44 is moved to the left in the view shown in FIG. 2 and into a position that blocks entry into the first passage 60 and the second passage 68. In so doing, the valve body 44 compresses the biasing element 54 between the fitting 50 and the valve body 44.

When the PLC 74—via the dispensing module 72—determines that adhesive 20 should be dispensed from the tip 58, the PLC 74 simultaneously directs movement of the robot 14 as well as opening of the applicator 12. Specifically, the PLC 74 directs the robot 14 to move in such a manner so as to place the applicator 12 in positions around the workpiece 18 where adhesive 20 is required. Such movement results in at least an arm 82 of the robot 14 moving relative to a base 84 of the robot 14 to allow the arm 82 to position the applicator 12 at locations on the workpiece that require adhesive 20 (FIG. 1).

Simultaneous with controlling movement of the robot 14 relative to the fixture 16 and the workpiece 18, the PLC 74 controls the amount of adhesive 20 dispensed from the tip 58 by controlling movement of the plunger 26 relative to and within the housing 22. Specifically, the PLC 74 sends an analog signal to the applicator 12, which is directed to the solenoid 24. The signal energizes the solenoid 24 and, depending on the strength of the signal, creates a magnetic field which, in turn, causes the plunger 26 to move relative to and within the housing 22 a desired amount. The strength of the applied signal will dictate how much the piston 42 moves within the bore 48 of the sleeve 38 which, in turn, dictates how much the valve body 44 moves relative to and within the bore 40 of the second portion 32 of the housing 22. As described above, the piston 42 is coupled to the valve body 44 by the connecting rod 46. Accordingly, when the piston 42 is moved relative to and within the bore 48 of the sleeve 38, the valve body 44 is likewise moved relative to and within the bore 40 of the second portion 32 of the housing 22.

Movement of the valve body 44 relative to and within the bore 40 of the second portion 32 of the housing 22 controls the amount of adhesive 20 dispensed from the tip 58. Specifically, the more the valve body 44 is moved away from the first portion 30 of the housing 22 (in the direction to the right shown in FIG. 2), the more the first passage 60 is placed in fluid communication with the second passage 68. When the valve body 44 is moved into the fully open position, as shown in FIG. 2, the first passage 60 is in full fluid communication with the second passage 68. At this point, adhesive 20 is directed into the housing 22 by the pump 70, which causes the adhesive 20 to move into the second passage 68, into the bore 40 of the second portion 32 of the housing 22, into the first passage 60, into the conduit 56, and finally into the tip 58 where the adhesive 20 is dispensed from the applicator 12 and applied to the workpiece 18.

If the dispensing module 72 determines that the applicator 12 does not need to be fully open, the dispensing module 72 can move the plunger 26 relative to and within the housing 22 such that the valve body 44 partially blocks both the first passage 60 and the second passage 68. In so doing, the dispensing module 72 restricts the amount of adhesive 20 that is permitted to flow from the reservoir 64 and out of the tip 58. Again, the amount of adhesive 20 permitted to flow from the tip 58 may be synchronized with the rate with which the robot 14 moves the applicator 12 relative to the workpiece 18. For example, if a larger bead of adhesive 20 is required, the faster the robot 14 moves the arm 82 relative to the workpiece 18, the more open the applicator 12 needs to be in order to supply a sufficient volume of adhesive 20. The converse is also true. Accordingly, the dispensing module 72 can control the valve body 44 to an infinite number of open positions relative to the housing 22 by controlling the analog signal supplied to the solenoid 24. In short, the valve body 44 may be positioned in a plurality of open positions between the fully closed position blocking openings to both passages 60, 68 and the fully open position shown in FIG. 2, thereby allowing the dispensing module 72 to control the volume of adhesive 20 dispensed from the tip 58 in a plurality of increments rather than simply allowing the valve body 44 to be fully open or fully closed.

As described above, the applicator 12 is a proportional valve. Accordingly, the dispensing module 72 is cable of controlling the applicator 12 to an infinite number of open positions to accurately control the volume of adhesive 20 dispensed from the applicator 12. In so doing, the dispensing module 72 is able to control the volume of adhesive 20 applied to a workpiece 18 and, further, can control the volume of adhesive based on the speed of the robot 14 supporting and moving the actuator 12 relative to the workpiece 18.

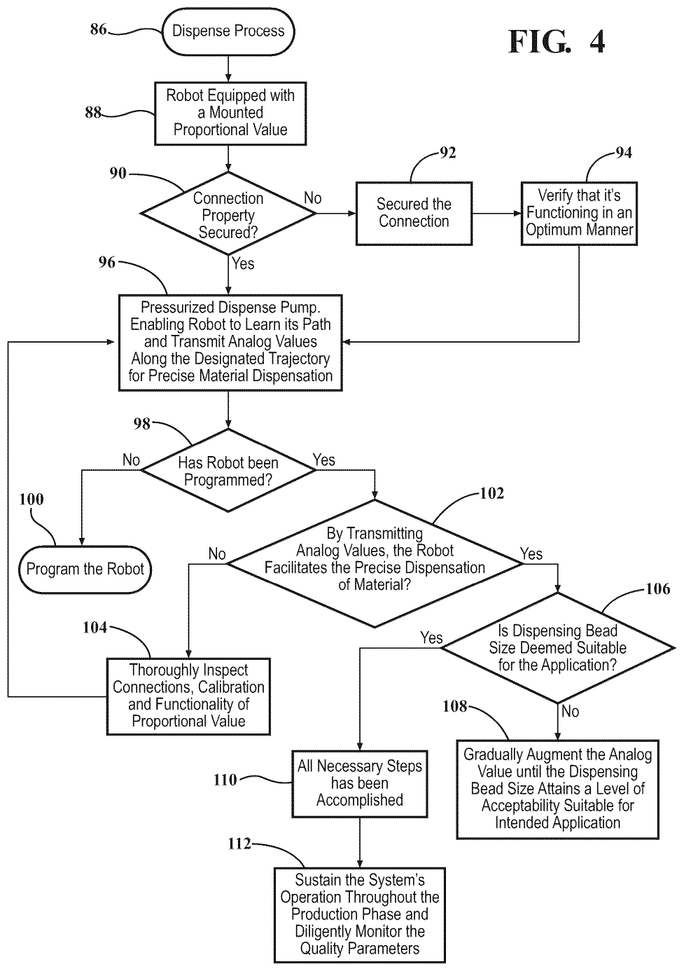

With reference to FIG. 4, operation of the FAS 10 will be described in detail. A process of dispensing adhesive 20 starts at 86. At 88, the dispensing module 72 is in communication with both the applicator 12 and the robot 14. As described above, the applicator 12 is a proportional valve, which is controlled by the dispensing module 72 in synchronization with movement of the robot 14.

At 90, the dispensing module 72 determines whether all connections are properly secured. If not, connections from the reservoir 64 to the applicator 12 are secured at 92. At this point, the dispensing module 72 may cycle the applicator 12 to make sure adhesive 20 is flowing through the applicator 12 from the reservoir 64 to the tip 58 at 94 in an effort to make sure all components are properly functioning.

If all connections are secure at 90 or after securing all connections at 92 and verifying proper operation of the applicator 12 at 94, the dispensing module 72 pressurizes the pump 70 at 96. The dispensing module 72 also instructs the robot 14 where to move the arm 82 relative to the workpiece 18 and determines what analog signals to send to the applicator 12 during movement of the arm 82 along the path at 96. At 98, the dispensing module 72 determines whether the robot 14 is programed. If not, the dispensing module 72 programs the robot 14 at 100. If the robot 14 is programmed, the dispensing module 72 determines whether the analog values transmitted to the applicator 12 result in a desired amount of adhesive 20 being dispensed at desired locations on the workpiece 18 at 102. In other words, the dispensing module 72 determines if the analog signal applied to the solenoid 24 results in the applicator 12 (i.e., the proportional valve) dispensing the correct volume of adhesive along the path of the arm 82. If not, the dispensing module 72 directs the inspection of all fluid connections and/or the calibration of the applicator 12 (i.e., the proportional valve) at 104.

If the correct volume of adhesive 20 is dispensed by the applicator 12 at 102, the dispensing module 72 determines if the bead of adhesive 20 disposed on the workpiece 18 is within a desired tolerance at 106. If not, the dispensing module 72 will adjust a position of the plunger 26 within the housing 22 at 108 until the bead of adhesive 20 on the workpiece 18 is within an acceptable range.

If the bead of material is within an acceptable range at 106, the dispensing module 72 determines that all steps have been properly completed at 110. At this point, the bead of adhesive 20 is properly applied to the workpiece 18 and the FAS 10 will continue to operate. The dispensing module 72 continually monitors the FAS 10 at 112 to make sure the bead size of the adhesive 20 is within a desired tolerance.

As described, the FAS 10 incorporates an applicator 12 which, as described above, is a proportional valve capable of being infinitely adjusted to supply the exact right amount of adhesive 20 during movement of an arm 82 of a robot 14 relative to a workpiece 18. In so doing, the FAS 10 ensures that the resulting bead size of the adhesive 20 on the workpiece 18 is correct throughout movement of the arm 82 around the workpiece 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fluid applicator system for applying fluid to a workpiece, the fluid applicator system comprising:
an arm movable relative to the workpiece; and
a proportional valve attached to the arm and movable with the arm relative to the workpiece, the proportional valve configured to dispense fluid onto the workpiece at predetermined locations when the arm is moved relative to the workpiece.

2. The fluid applicator system of claim 1, wherein the proportional valve is in fluid communication with a reservoir containing the fluid.

3. The fluid applicator system of claim 2, further comprising a pump in fluid communication with the fluid disposed in the reservoir, the pump configured to direct fluid from the reservoir into the proportional valve.

4. The fluid applicator system of claim 3, wherein the proportional valve includes a housing and a valve body slidably disposed within the housing and movable into a plurality of open positions between a fully closed position preventing flow of the fluid from the reservoir to the workpiece and a fully open position permitting flow of the fluid from the reservoir to the workpiece, the plurality of open positions providing different flow volumes of the fluid through the proportional valve to the workpiece.

5. The fluid applicator system of claim 1, wherein the fluid is an adhesive.

6. The fluid applicator system of claim 1, wherein the fluid is a sealant.

7. The fluid applicator system of claim 1, wherein the fluid is a combination adhesive/sealant.

8. The fluid applicator system of claim 1, wherein a volume of fluid dispensed by the proportional valve is synchronized with movement of the arm to dispense fluid onto the workpiece at a predetermined bead size.

9. The fluid applicator system of claim 1, wherein the proportional valve includes a solenoid configured to move a valve body relative to and within a housing of the proportional valve to control the volume of fluid dispensed from the proportional valve onto the workpiece.

10. The fluid applicator system of claim 9, wherein the valve body is configured to be moved into a plurality of open positions to control a volume of fluid dispensed from the housing based on an analog signal applied to the solenoid.

11. A system comprising:
data processing hardware; and
memory hardware in communication with the data processing hardware, the memory hardware storing instructions that when executed on the data processing hardware cause the data processing hardware to perform operations comprising:
programming a path-of-movement of an arm relative to a workpiece, the path-of-movement defining a bead location of at least one of an adhesive and a sealant;
moving a proportional valve with the arm relative to the workpiece, the proportional valve moving with the arm along the path-of-movement; and
moving a valve body of the proportional valve from a closed position to one of a plurality of open positions to dispense a fluid from the proportional valve onto the workpiece as the arm and the proportional valve are moved along the path-of-movement.

12. The system of claim 11, wherein the proportional valve is in fluid communication with a reservoir containing the at least one of the adhesive and the sealant.

13. The system of claim 12, wherein the at least one of the adhesive and the sealant is directed to the proportional valve by a pump in fluid communication with the at least one of the adhesive and the sealant disposed within the reservoir.

14. The system of claim 11, wherein a speed of the arm is synchronized with a position of the valve body to dispense the fluid onto the workpiece at a desired bead size.

15. The system of claim 11, wherein moving the valve body from a closed position to one of a plurality of open positions includes supplying the proportional valve with an analog signal.

16. The system of claim 15, wherein supplying the proportional valve with an analog signal includes supplying the analog signal to a solenoid associated with the proportional valve.

17. The system of claim 11, wherein the proportional valve includes a piston and a connecting rod, the connecting rod extending between and connecting the piston and the valve body.

18. The system of claim 17, wherein the proportional valve includes a solenoid disposed proximate to the piston, the solenoid configured to move the piston relative to a housing of the proportional valve in response to a signal received by the solenoid.

19. The system of claim 18, wherein the signal is an analog signal.

20. The system of claim 18, wherein movement of the piston relative to the housing causes simultaneous movement of the valve body into the closed position or one of the plurality of open positions.
